(19) United States
(12) Patent Application Publication
(10) Pub. No.: US 2014/0193228 A1
(43) Pub. Date: Jul. 10, 2014

(54) Hazard-Free Sweeping Grain Bin Vacuum Arm

(71) Applicant: Brad Scholl, Ankeny, IA (US)

(72) Inventor: Brad Scholl, Ankeny, IA (US)

(21) Appl. No.: 13/738,394

(22) Filed: Jan. 10, 2013

(51) Int. Cl. B65G 65/48

(52) U.S. Cl. CPC B65G 65/4854
USPC 414/306; 414/808

(57) ABSTRACT

The present invention relates to an improved device and method for removing grain or other particulate matter from a grain bin. The invention comprises a sweeping arm having inlets, a joint, and a vacuum tube in operational communication with the sweeping arm. The sweeping arm is passed around the circumference of the grain bin around the joint, so that the particulate matter can be collected by way of the inlets in the sweeping arm and the vacuum. A handcart may be used to propel the arm around the joint. The inlets are of adjustable size.

### CROSS-REFERENCE TO RELATED APPLICATION(S)

None.

### FIELD OF THE INVENTION

The present invention relates generally to an apparatus and method for removing particulate matter from vessels. More particularly, the present invention relates to an adjustable vacuum sweep for placement in a grain bin to remove various grains and other matter from the interior of the bin for transfer to another location.

### BACKGROUND OF THE INVENTION

Grain bins are well known, and are generally cylindrical storage units. They are a variety of shapes and, though they are generally circular at the base, with diameters up to and exceeding 40 feet, for storage of thousands of bushels of grain or other agricultural or particulate matter. Bin floors may be composed of poured concrete, to which the walls are attached. These walls are typically comprised of stainless steel, though other materials are possible. Generally, grain bins will have a variety of access ports either at the top, bottom, or both.

Occupational Safety and Health Administration (“OSHA”) regulations relating to the cleaning of bins have changed the practice of entering and cleaning grain bins. These “lockout/tagout” procedures (29 CFR 1910.272) have been introduced to curb the risks associated with augers, being engulfed grain, grain dust fires, explosions, suffocations and certain other safety hazards. These procedures are increasingly strict, having last been amended in December of 2011, thus causing an increase in the safety of grain bins but also an increase in the amount of time and energy required to, for example, clean a bin by conventional means.

Thus, there is a need in the art for an improved apparatus and method for removing grain or other particulate matter from the inside of a grain bin or other large storage vessel.

### BRIEF SUMMARY OF THE INVENTION

Discussed herein are various apparatus and methods for use in bins, specifically grain bins. More specifically, the present invention relates to vacuums and other methods of cleaning and/or removing material from the interior of such bins.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a side view of a grain bin containing one embodiment of the present invention.

FIG. 2 is a side view of the particular embodiment of the joint shown in FIG. 1.

FIG. 3. Is a perspective view of one embodiment of the present invention showing manual operation.

FIG. 4 is an expanded view of the embodiment of FIG. 3 showing the opposite angle.

FIG. 4A is an end view of the embodiment of FIG. 4.

FIG. 5 is a perspective detail view of the mast of the embodiment of the present invention in FIG. 3.

FIG. 5A is a further detail view of the mast from the embodiment of the present invention shown in FIG. 3.

FIG. 5B is a further detail view of the mast from the embodiment of the present invention shown in FIG. 3.

### DETAILED DESCRIPTION

The various systems and devices disclosed herein relate to apparatus and methods for use in the cleaning of bins. More specifically, the various embodiments relate grain bin vacuums and related methods and components. It is understood that the various embodiments of the apparatus and method disclosed herein are exemplary.

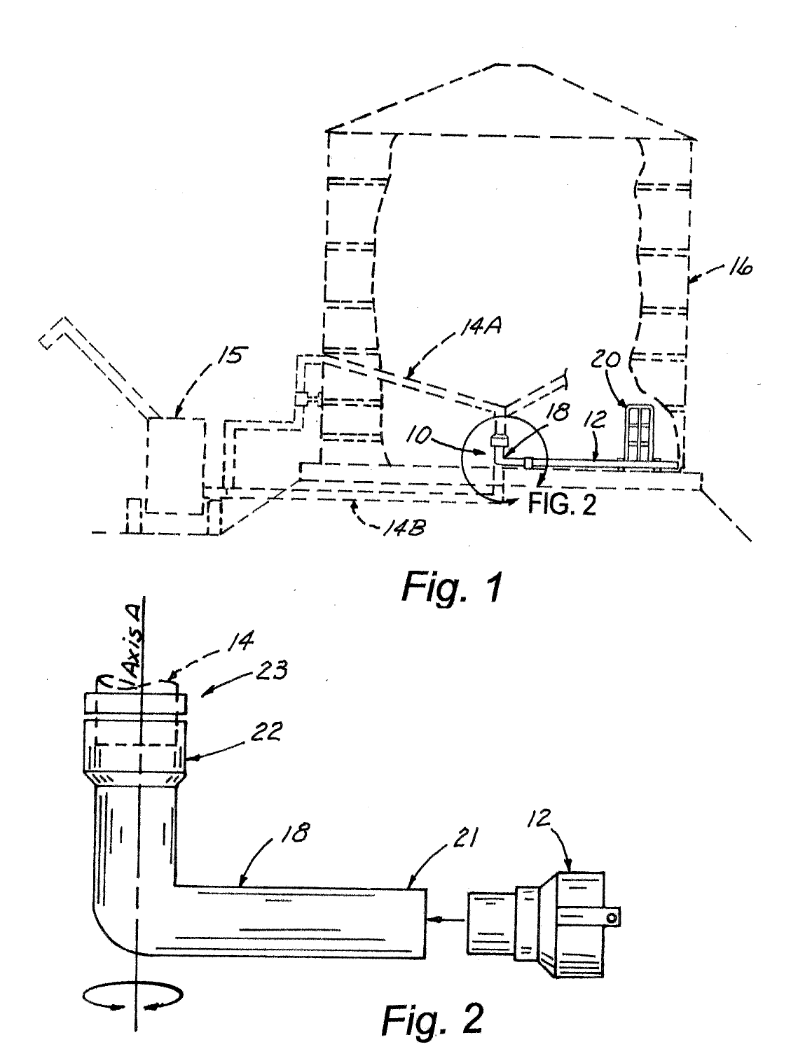

FIGS. 1-5B depict various embodiments of the present grain bin vacuum system that can be used in the removal of material from within a bin.

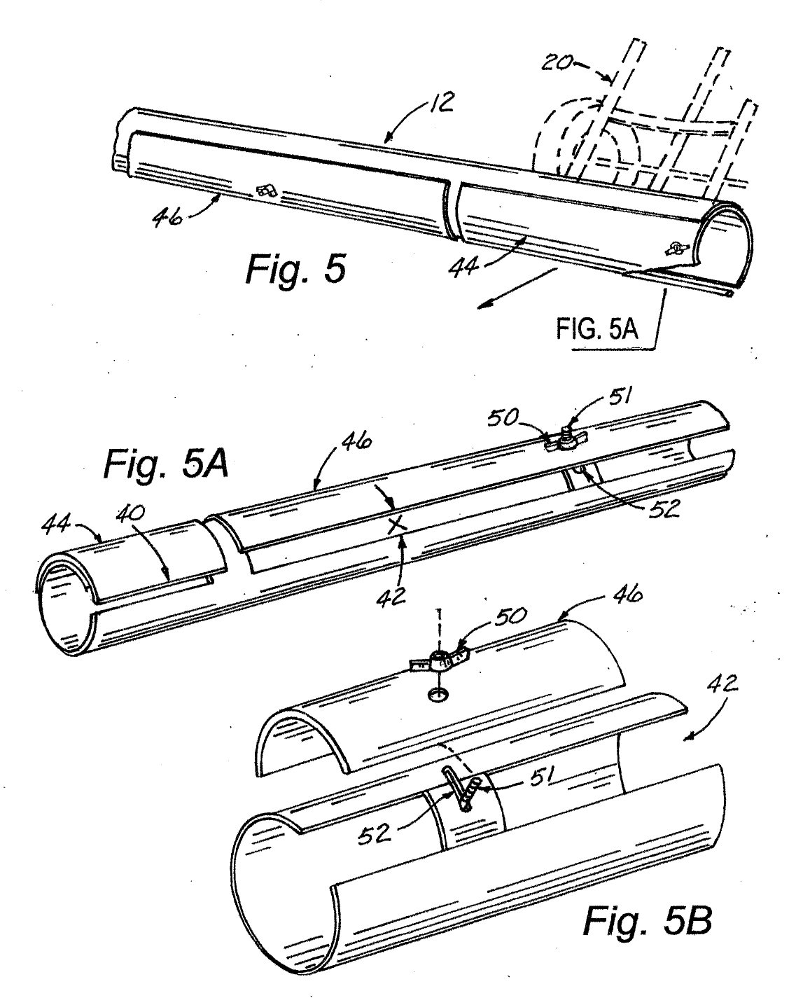

As best shown in FIG. 1, the certain embodiments of the present invention relate to a grain bin vacuum, generally at 10. In these embodiments, the present invention typically operates by converting a conventional bin sweep arm 12—such as an auger or paddle sweep—into a vacuum by introducing inlets or slots (best shown as 40, 42 in FIG. 5A) on the underside or otherwise located on the sweeping arm 12. Such augers are in wide use to convey particulate materials, such as grain. However, augers typically have a discrete, distal opening (best shown capped 30 in FIGS. 4-4A). Exemplary embodiments of the present invention, however, include these inlets 40, 42 along substantially the entirety of the shaft of the sweeping arm 12, so as to further increase efficiency when vacuuming the particulate matter. In certain exemplary embodiments, the sweeping arm also includes at least one support rod, running substantially parallel with the sweeping arm 12 to provide further rigidity.

As further shown in FIG. 1, the sweeping arm 12 is typically attached to a vacuum suction tube 14A, 14B run to a vacuum 15 either temporarily or permanently mounted either under 14B or otherwise outside 14A of the grain bin 16, typically by way of a joint 18. While the above-ground exit tube 14A is shown to run substantially diagonally to established manholes in the Figures, other embodiments of the present invention include running the exit tube downward from a central pivot point in the grain bin. In these embodiments, a removable floor can be employed as a means for easy access to the underside for cleaning and maintenance. In other embodiments, openings, such as hatches or slides can be used for access to the underside.

In preferred embodiments, the vacuum source is run with at least two explosion-proof electric motors, though many other embodiments would be apparent to one of skill in the art. These motors can be controlled remotely; by a control station or other remote control apparatus mounted either outside or inside the bin itself. In preferred embodiments, vacuums such as Walinga® grain vacuums can be used, and the corresponding joint connection (best described in relation to FIG. 2) be of appropriate size so as to accomidate for the standard sizes.

In certain exemplary embodiments, a modified handcart 20 can be used as a means to swing the sweeping arm 12 around the circumference of the bin 16, though as would be apparent to one of skill in the art, other OSHA-approved means are possible, such as mounted electric motors and tires or other means. In each of these embodiments, it is preferred if the sweeping arm can rotate through the 360 degrees around a central pivot, or some other configuration so that the maximal amount of floor space is covered.

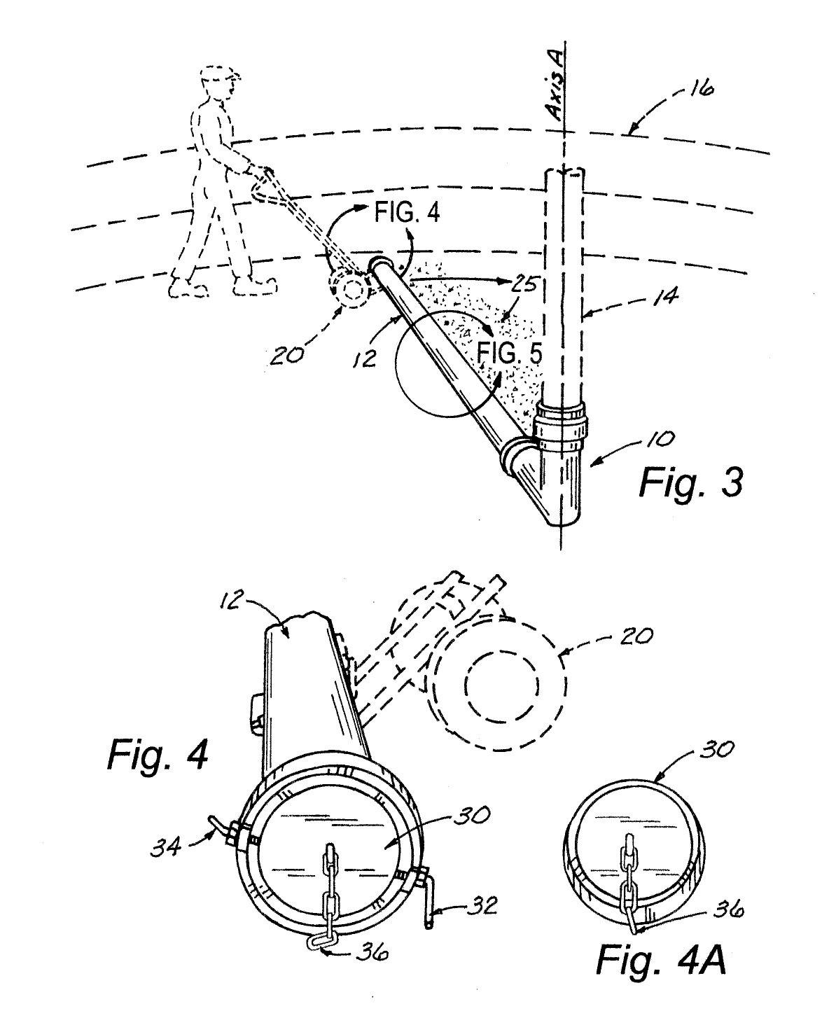

As best shown in FIG. 2, in exemplary embodiments of the present invention, the joint 18 of the arm 12 has male and/or female connection regions 21, 22, 23, adapted to couple with the vacuum tube 14 and arm 12. In the embodiment shown in FIG. 2, the connection between the joint 18 and arm 12 is female-to-male, the inverse is also shown elsewhere, such as in FIG. 3. Likewise, while the connection between the joint and the vacuum tube depicted is female-to-male, the inverse is also possible, depending upon the type of vacuum used. These connections are well known and standard in the art. While the joint 18 depicted in FIG. 2 appears as a right angle from the sweep arm, many other configurations are possible, depending upon the orientation of the vacuum tube, floor, and means by which arm 12 moves.

As is shown in FIG. 3, in certain embodiments of the present invention, a handcart 20 can be adapted to propel the sweep arm 12 around the circumference of the bin 16 to pick up the grain or other particulate matter 25. In these embodiments, the joint 18 is free to pivot, so as to allow fluid motion around the axis (here, Axis A). This use of vacuums meets OSHA lockout/tagout requirements and prevents the chance of workers being engulfed or otherwise injured by augers, and the like. While a worker cannot enter a grain bin, for example, while an auger or paddle sweep is running, they are allowed to while using a vacuum.

As is shown in FIG. 4-4A, the distal end of the sweep arm is typically plugged 30 while in use. As is depicted here, the plug 30 is a male component, though other configurations such as female may be utilized and are within the spirit of the invention. In the example depicted herein, the plug utilizes clamps 32, 34 and a chain 36 as means for securing and removing it from the arm 12. Other methods and configurations are possible. In all of these embodiments, the plug 30 can be pulled, and possibly the inlets 40, 42 colosed, following rotations about the grain bin, so as to remove the grain from the edges of the bin.

As is best depicted in FIGS. 5-5B, in the present embodiment the inlets 40, 42 are of adjustable size so as to control the flow rate and allow for customization to specific sizes of grain. While this exemplary embodiment depicts the use of multiple rectangular inlets 40, 42 other configurations are possible. Further, while in this embodiment uses wingnuts 50, bolts 51 and slotted supports 52 and over shields 44, .46 adjust the size of the inlets 40, 42, other configurations are possible, as would be apparent to one of skill in the art. Further, as differing sizes and shapes of inlets or slots can be utilized, depending on the specific implementation.

Although the present invention has been described with reference to preferred embodiments, persons skilled in the art will recognize that changes may be made in form and detail without departing from the spirit and scope of the invention.

What is claimed is:

1. An grain bin cleaning apparatus, comprising:
a) an arm, further comprising inlets;
b) a vacuum in operational communication with the arm; and
c) a pivoting joint, wherein the pivoting joint is in operational communication with the arm and vacuum allows the arm to rotate around grain bins so that particulate matter may enter the vacuum tube.

2. The apparatus of claim 1, wherein the intake slots are longitudinal along the arm.

3. The apparatus of claim 1, wherein the intake slots are of adjustable size.

4. The apparatus of claim 3, wherein the arm further comprises an over shied and a wingnut, wherein the over shield is movable relative to the arm and able to be held in place by way of the wingnut so as to adjust the size of the inlets.

5. The apparatus of claim 1, wherein the arm further comprises at least one support rod.

6. The apparatus of claim 1 further comprising a conveyance for moving the arm around the grain bin.

7. The apparatus of claim 6, wherein the conveyance is a hand cart.

8. An apparatus for cleaning grain bins, comprising:
a) a sweeping arm;
b) a pivoting joint;
c) a vacuum tube; and
d) a means of rotating the sweeping arm around the joint so as to allow the vacuum to collect particulate matter through the sweeping arm.

9. The apparatus of claim 8, wherein the means of rotating the sweeping arm is a handcart.

10. The apparatus of claim 8, further comprising at least one support rod attached to the sweeping arm.

11. The apparatus of claim 8, wherein the intake slots are longitudinal along the arm.

12. The apparatus of claim 8, wherein the intake slots are of adjustable size.

13. The apparatus of claim 12, wherein the arm further comprises an over shied and a wingnut, wherein the over shield is movable relative to the arm and able to be held in place by way of the wingnut so as to adjust the size of the inlets.

14. A method of cleaning a grain bin, comprising:
a) providing a vacuum;
b) providing a sweeping arm further comprising inlets;
c) connecting the sweeping arm to the vacuum by way of a pivoting joint;
d) moving the sweeping arm around the grain bin so as to collect particulate matter through the inlets with the vacuum.

15. The method of claim 14, further comprising providing a conveyance for moving the sweeping arm.

16. The method of claim 15, wherein the conveyance is a hand cart.

17. The method of claim 14, further comprising providing at least one support rod on the sweeping arm.

18. The method of claim 14, further comprising providing an over shied and a wingnut, wherein the over shield is movable relative to the arm and able to be held in place by way of the wingnut so as to adjust the size of the inlets.
